(19) United States
(12) Patent Application Publication
(10) Pub. No.: US 2023/0369599 A1
(43) Pub. Date: Nov. 16, 2023

(54) BORIC ACID DERIVATIVE MODIFIED BINDER AND LITHIUM-ION BATTERY INCLUDING SAME

(71) Applicant: Zhuhai CosMX Battery Co., Ltd., Guangdong (CN)

(72) Inventors: Lin CHU, Guangdong (CN); Panlong GUO, Guangdong (CN); Weiping CHEN, Guangdong (CN); Suli LI, Guangdong (CN); Junyi LI, Guangdong (CN)

(21) Appl. No.: 18/225,642

(22) Filed: Jul. 24, 2023

Related U.S. Application Data
(63) Continuation of application No. PCT/CN2022/081028, filed on Mar. 15, 2022.

(30) Foreign Application Priority Data
Mar. 15, 2021 (CN) 2021102780313

(51) Int. Cl. H01M 4/62; H01M 10/0525; C08F 230/06; H01M 4/04

(52) U.S. Cl. CPC H01M 4/622; H01M 10/0525; C08F 230/06; H01M 4/0404; H01M 2004/021

(57) ABSTRACT

The present application provides a boric acid derivative modified binder and a lithium-ion battery including the binder. Surfaces of emulsion particles of the binder are rich in boric acid groups (—B(OH)₂). When the binder is applied to an electrode piece of the battery, the boric acid groups can be subjected to a dehydration condensation reaction with —OH in sodium carboxymethyl cellulose dispersant, or with —OH in a functional monomer during the drying process of the electrode piece, to form a three-dimensional network, increasing the bonding force and greatly improving the peeling strength of the electrode piece. The binder can also significantly improve the cycle performance of the lithium-ion battery, thereby prolonging the cycle life of the lithium-ion battery.

### CROSS-REFERENCE TO RELATED APPLICATION

The present application is a continuation of International Application No. PCT/CN2022/081028, filed on Mar. 15, 2022, which claims priority to Chinese Patent Application No. 202110278031.3, filed on Mar. 15, 2021, entitled “Boric Acid Derivative Modified Binder and Lithium-Ion Battery Including Same.” The aforementioned patent applications are hereby incorporated by reference in their entireties.

### TECHNICAL FIELD

The present application relates to a boric acid derivative modified binder and lithium-ion battery including the binder, belonging to the technical field of lithium-ion batteries, in particular to the technical field of binders of lithium-ion batteries.

### BACKGROUND

Binder as a polymer in a lithium-ion battery not only plays a role of bonding between active material layers, but also can be used for bonding between an active material layer and a substrate of electrode piece. It plays an important role in manufacture and performance of lithium-ion battery and is one of important components of the battery.

At present, the most widely used emulsion-type binders in the industry include SBR emulsion formed by a copolymer of styrene and butadiene, and styrene-acrylate emulsion formed by a copolymerization of styrene and acrylate. The adhesive films formed by these emulsions are elastomers with different degrees of cross-linking, which can play a role of bonding. However, there is only van der Waals force and no chemical interaction between the particles in this kind of emulsions, and thus an effective three-dimensional bonding network cannot be formed in use, which results in a poor expansion inhibition of the battery during cycling process of the battery. Therefore, it is urgent to develop a functional emulsion-type binder so that it can form an effective three-dimensional bonding network and improve the performance of the battery.

### SUMMARY

In order to solve the problem of poor bonding performance of the existing binder, the present application provides a boric acid derivative modified binder and a lithium-ion battery including the binder, the bonding performance of the boric acid derivative modified binder is significantly higher than that of the existing binder, and the mechanical stability of the film prepared therefrom is also improved.

The present application is realized through the following technical solution:

A copolymer, which is a copolymer of a matrix monomer and a comonomer shown in Formula (1):

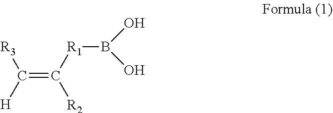

in Formula (1), R₁ is selected from —C₁₋₆alkylidene-, —C₆₋₁₂arylene- and —C(═O)—O—C₆₋₁₂arylene-; R₂ is selected from —H and —C₁₋₆alkyl; and R₃ is selected from —H and —C₁₋₆alkyl.

According to the present application, the matrix monomer is selected from at least one of compounds shown in Formulas (2) and (3):

H₂C═CH—R₄ Formula(2)

H₂C═C(CH₃)—R₄ Formula (3)
in Formulas (2) and 3, R₄ is selected from —C(R₅)═C(R₅)₂, —C₆₋₁₂aryl and —C(═O)—O—R₆; wherein each R₅ is same or different, and independently selected from —H and —C₁₋₆alkyl; and R₆ is selected from substituted or unsubstituted —C₁₋₆alkyl, with substitute group being selected from hydroxyl group.

According to the present application, the comonomer shown in Formula (1) is selected from at least one of compounds shown in Formulas (1-1), (1-2), (1-3), (1-4) and (1-5):

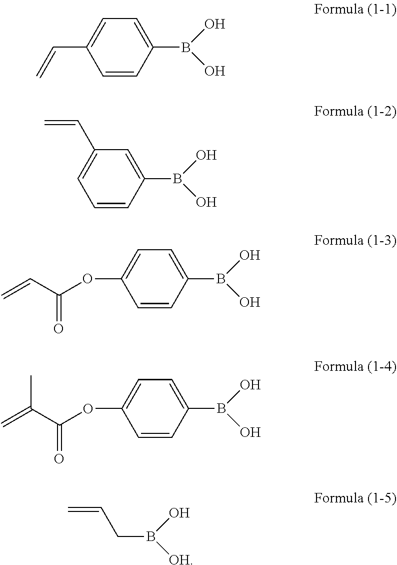

According to the present application, the copolymer is a copolymer of a matrix monomer, a comonomer shown in Formula (1) and a functional monomer, the functional monomer is selected from at least one of acrylonitrile, (meth)acrylamide, (meth)acrylic acid, itaconic acid, 2-acrylamido-2-methylpropanesulfonic acid, allyl sulfonic acid, N-hydroxymethyl (meth)acrylamide, N,N-dimethyl acrylamide, sodium p-styrene sulfonate, sodium vinyl sulfonate, sodium allyl sulfonate, sodium 2-methylallyl sulfonate, sodium ethyl methacrylate sulfonate, hydroxyethyl (meth)acrylate, hydroxypropyl (meth)acrylate or dimethyl diallyl ammonium chloride. The introduction of the functional monomer is beneficial to improve the property of the copolymer, such as dispersion stability of an emulsion formed by the copolymer in water and the adhesion of the emulsion to an active material.

According to the present application, the matrix monomer is selected from butadiene and styrene; or, the matrix monomer is selected from at least one of alkyl (meth)acrylate and hydroxyalkyl (meth)acrylate; or, the matrix monomer is selected from styrene and at least one of the following compounds: alkyl (meth)acrylate and hydroxyalkyl (meth)acrylate.

According to the present application, when the matrix monomer is selected from butadiene and styrene, the copolymer is, for example, a copolymer of the comonomer (boric acid derivative) shown in Formula (1), butadiene and styrene, or a copolymer of the comonomer (boric acid derivative) shown in Formula (1), butadiene, styrene and the functional monomer.

According to the present application, when the matrix monomer is selected from at least one of alkyl (meth)acrylate and hydroxyalkyl (meth)acrylate, the copolymer is, for example, a copolymer of at least one of alkyl (meth)acrylate and hydroxyalkyl (meth)acrylate and the comonomer (boric acid derivative) shown in Formula (1), or a copolymer of at least one of alkyl (meth)acrylate and hydroxyalkyl (meth)acrylate, the comonomer (boric acid derivative) shown in Formula (1) and the functional monomer.

According to the present application, when the matrix monomer includes styrene and at least one of the following compounds: alkyl (meth)acrylate and hydroxyalkyl (meth)acrylate, the copolymer is, for example, a copolymer of at least one of alkyl (meth)acrylate and hydroxyalkyl (meth)acrylate, the comonomer (boric acid derivative) shown in Formula (1) and styrene, or a copolymer of at least one of alkyl (meth)acrylate and hydroxyalkyl (meth)acrylate, the comonomer (boric acid derivative) shown in Formula (1), styrene and the functional monomer.

According to the present application, the comonomer shown in Formula (1) accounts for 0.1-10 wt % of a total mass of the copolymer, in an implementation, the comonomer shown in Formula (1) accounts for 1-5 wt % of the total mass of the copolymer.

According to the present application, the matrix monomer accounts for 90-99.9 wt % of the total mass of the copolymer, in an implementation, the matrix monomer accounts for 95-99 wt % of the total mass of the copolymer.

According to the present application, the functional monomer accounts for 0-10 wt % of the total mass of the copolymer, in an implementation, the functional monomer accounts for 0.1-5 wt % of the total mass of the copolymer.

According to the present application, a glass transition temperature of the copolymer is −20° C.-80° C.

The present application further provides a binder including the above copolymer.

According to the present application, the binder is an emulsion-type binder.

Wherein a particle size of the emulsion-type binder is 100-800 nm, in an implementation, 100-300 nm.

Wherein a polydispersity index (PDI) of the emulsion-type binder is not more than 0.3, in an implementation, not more than 0.1.

Wherein a viscosity of the emulsion-type binder is 10-500 mPa·s, in an implementation, 50-250 mPa·s.

Wherein a solid content of the emulsion-type binder is 1-70 wt %, such as 5-65 wt %, 10-60 wt %, further such as 20-60 wt %, more further such as 30-60 wt %, in an implementation, 40-60 wt %.

The present application further provides an electrode piece, including a current collector and an active material layer located on a surface of at least one side of the current collector, where the active material layer includes the above binder, a mass of the binder accounts for 0.5-5 wt % of a total mass of the active material layer, such as 0.8-2.5 wt %, and further such as 1.5-2.5 wt %.

The present application further provides a lithium-ion battery, including the above binder and/or the above electrode piece.

The present application have the following beneficial effects:

The present application provides a boric acid derivative modified binder and a lithium-ion battery including the binder. Surfaces of emulsion particles of the binder are rich in boric acid groups (—B(OH)₂). When the binder is applied into an electrode piece of the battery, the boric acid groups can be subjected to a dehydration condensation reaction with —OH in sodium carboxymethyl cellulose as dispersant, or with —OH in the functional monomer during the drying of the electrode piece, to form a three-dimensional network, such that the bonding force is increased and the peeling strength of the electrode piece is greatly improved. The binder can also significantly improve the cycle performance of a lithium-ion battery at ambient and low temperatures, thereby prolonging the cycle life of the lithium-ion battery. Compared with a conventional binder, the cycle capacity retention rate of the lithium-ion battery using the binder of the present application is higher, and the expansion rate of the lithium-ion battery after cycling is lower, and thus the expansion rate of the lithium-ion battery after long-term use can be significantly inhibited, and meanwhile the low-temperature performance of the lithium-ion battery using the binder in the present application has also been significantly improved.

### BRIEF DESCRIPTION OF DRAWINGS

FIG. 1 is an infrared spectrum diagram of binders of Example 1 and Comparative Example 1.

FIG. 2 is a schematic structural diagram of a device for testing peeling strength of a binder.

### DESCRIPTION OF EMBODIMENTS

[Copolymer]

As described above, the present application provides a copolymer, which is a copolymer of a matrix monomer and a comonomer shown in Formula (1):

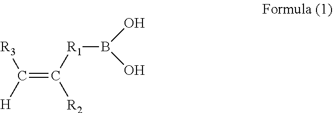

in Formula (1), R₁ is selected from —C₁₋₆alkylidene-, —C₆₋₁₂arylene-, —C(═O)—O—C₆₋₁₂arylene-; R₂ is selected from —H, —C₁₋₆alkyl; and R₃ is selected from —H, —C₁₋₆alkyl.

In an embodiment, the matrix monomer is selected from at least one of compounds shown in Formulas (2) and (3):

H₂C═CH—R₄ Formula (2)

H₂C═C(CH₃)—R₄ Formula (3)
in Formulas (2) and (3), R₄ is selected from —C(R₅)═C(R₅)₂, —C₆₋₁₂ aryl, —C(═O)—O—R₆; wherein each R₅ is same or different, and independently selected from —H, —C₁₋₆alkyl; and R₆ is selected from substituted or unsubstituted —C₁₋₆alkyl, with substitute groups being selected from hydroxyl group.

Exemplarily, the matrix monomer is selected from at least one of butadiene, styrene, alkyl (meth)acrylate and hydroxyalkyl (meth)acrylate.

In an embodiment, R₁ is selected from —C₁₋₃alkylidene-, —C₆H₄—, and —C(═O)—O—C₆H₄—; R₂ is selected from —H, and —C₁₋₃alkyl; and R₃ is selected from —H, and —C₁₋₃alkyl.

In an embodiment, R₁ is selected from —CH₂—, —CH₂CH₂—, —CH₂CH₂CH₂—, —CH₂CH(CH₃)—, —C₆H₄—, and —C(═O)—O—C₆H₄—; R₂ is selected from —H, —CH₃, —CH₂CH₃—, —CH₂CH₂CH₃—, and —CH(CH₃)—; and R₃ is selected from —H, —CH₃, —CH₂CH₃—, —CH₂CH₂CH₃—, and —CH(CH₃)₂.

In an embodiment, the comonomer shown in Formula (1) is a boric acid derivative with an unsaturated bond, that is, the comonomer shown in Formula (1) is a boric acid derivative.

In an embodiment, the comonomer shown in Formula (1) is selected from at least one of compounds shown in Formulas (1-1), (1-2), (1-3), (1-4) and (1-5):

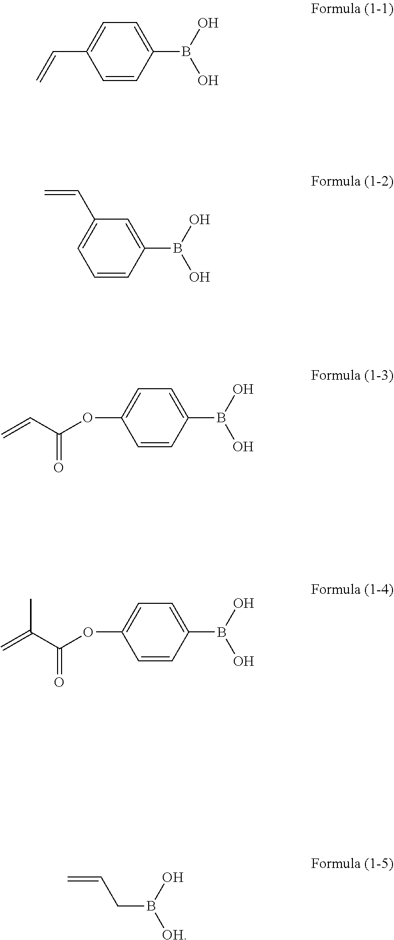

In an embodiment, the copolymer is a copolymer of the matrix monomer, the comonomer shown in Formula (1) and a functional monomer.

In an embodiment, the functional monomer is selected from at least one of acrylonitrile, (meth)acrylamide, (meth)acrylic acid, itaconic acid, 2-acrylamido-2-methylpropanesulfonic acid, allyl sulfonic acid, N-hydroxymethyl (meth)acrylamide, N,N-dimethyl acrylamide, sodium p-styrene sulfonate, sodium vinyl sulfonate, sodium allyl sulfonate, sodium 2-methylallyl sulfonate, sodium ethyl methacrylate sulfonate, hydroxyethyl (meth)acrylate, hydroxypropyl (meth)acrylate and dimethyl diallyl ammonium chloride. The introduction of the functional monomer is beneficial to improve the property of the copolymer, such as dispersion stability of an emulsion formed by the copolymer in water and the adhesion of the emulsion to an active material.

In an embodiment, the matrix monomer is selected from butadiene and styrene; or, the matrix monomer is selected from at least one of alkyl (meth)acrylate and hydroxyalkyl (meth)acrylate; or, the matrix monomer is selected from styrene and at least one of the following compounds: alkyl (meth)acrylate and hydroxyalkyl (meth)acrylate.

Exemplarily, the alkyl (meth)acrylate is selected from at least one of butyl methacrylate, butyl acrylate, methyl methacrylate, methyl acrylate, ethyl methacrylate, ethyl acrylate, n-octyl methacrylate, n-octyl acrylate, isooctyl methacrylate, isooctyl acrylate and dodecyl methacrylate.

Exemplarily, the hydroxyalkyl (meth)acrylate is selected from at least one of hydroxyethyl methacrylate, hydroxyethyl acrylate, hydroxypropyl methacrylate and hydroxypropyl acrylate.

In an embodiment, when the matrix monomer is selected from butadiene and styrene, the copolymer is, for example, a copolymer of the comonomer (boric acid derivative) shown in Formula (1), butadiene and styrene, or a copolymer of the comonomer (boric acid derivative) shown in Formula (1), butadiene, styrene and the functional monomer.

In an embodiment, when the matrix monomer is selected from at least one of alkyl (meth)acrylate and hydroxyalkyl (meth)acrylate, the copolymer is, for example, a copolymer of at least one of alkyl (meth)acrylate and hydroxyalkyl (meth)acrylate and the comonomer (boric acid derivative) shown in Formula (1), or a copolymer of at least one of alkyl (meth)acrylate and hydroxyalkyl (meth)acrylate, the comonomer (boric acid derivative) shown in Formula (1) and the functional monomer.

In an embodiment, when the matrix monomer includes styrene and at least one of the following compounds: alkyl (meth)acrylate and hydroxyalkyl (meth)acrylate, the copolymer is, for example, a copolymer of at least one of alkyl (meth)acrylate and hydroxyalkyl (meth)acrylate, the comonomer (boric acid derivative) shown in Formula (1) and styrene, or a copolymer of at least one of alkyl (meth)acrylate and hydroxyalkyl (meth)acrylate, the comonomer (boric acid derivative) shown in Formula (1), styrene and the functional monomer.

In the present application, the introduction of the comonomer (boric acid derivative) shown in Formula (1) in the copolymer enables the surfaces of emulsion particles of the copolymer to be enriched with boric acid groups (—B(OH)₂), which exist stably in the aqueous emulsion. When the aqueous emulsion is used for a binder for a lithium-ion battery, it is easy to undergo a dehydration reaction with hydroxyl (—OH) in the drying process of electrode piece. The —OH can be derived from —B(OH)₂ near the surfaces of the emulsion particles, —OH in sodium carboxymethyl cellulose (a commonly used dispersant in lithium-ion batteries), and —OH in the functional monomer; after chemical cross-linking, a three-dimensional bonding network is formed, increasing the bonding strength, and thereby improving the performance of the battery.

In an embodiment, the comonomer shown in Formula (1) accounts for 0.1-10 wt % of a total mass of the copolymer. In an implementation, the comonomer shown in Formula (1) accounts for 1-5 wt % of the total mass of the copolymer. For example, the comonomer shown in Formula (1) accounts for 0.1 wt %, 0.3 wt %, 0.5 wt %, 0.8 wt %, 1 wt %, 2 wt %, 3 wt %, 4 wt %, 5 wt %, 8 wt % or 10 wt % of a total mass of the copolymer.

In an embodiment, the matrix monomer accounts for 90-99.9 wt % of the total mass of the copolymer. In an implementation, the matrix monomer accounts for 95-99 wt % of the total mass of the copolymer. For example, the matrix monomer accounts for 90 wt %, 92 wt %, 95 wt %, 96 wt %, 97 wt %, 98 wt %, 99 wt %, 99.2 wt %, 99.5 wt %, 99.7 wt % or 99.9 wt % of the total mass of the copolymer.

In an embodiment, the functional monomer accounts for 0-10 wt % of the total mass of the copolymer. In an implementation, the functional monomer accounts for 0.1-5 wt % of the total mass of the copolymer. For example, the functional monomer accounts for 0 wt %, 0.1 wt %, 0.2 wt %, 0.3 wt %, 0.4 wt %, 0.5 wt %, 0.8 wt %, 1 wt %, 2 wt %, 3 wt %, 4 wt %, or 5 wt % of the total mass of the copolymer.

In an embodiment, the copolymer is a random copolymer or a block copolymer, in an implementation, a random copolymer.

In an embodiment, a glass transition temperature of the copolymer is −20° C. to 80° C.

In an embodiment, a weight average molecular weight of the copolymer is 250,000 to 1, 500,000.

[Boric Acid Derivative Modified Binder]

As described above, the present application further provides a binder including the above copolymer.

In an embodiment, the binder is prepared by polymerization of the comonomer (boric acid derivative) shown in Formula (1), the matrix monomer and in an implementation, the functional monomer.

In an embodiment, the binder is an emulsion-type binder, and specifically, the copolymer is dispersed in a dispersion medium (such as water) to obtain the emulsion-type binder.

In an embodiment, when the matrix monomer is butadiene and styrene, the prepared binder is an emulsion-type binder. Specifically, a copolymer of the comonomer (boric acid derivative) shown in Formula (1), butadiene and styrene, or a copolymer of comonomer (boric acid derivative) shown in Formula (1), butadiene, styrene and the functional monomer are dispersed in a dispersion medium (such as water) to prepare the emulsion-type binder.

In an embodiment, when the matrix monomer is styrene and at least one of the following compounds: alkyl (meth)acrylate and hydroxyalkyl (meth)acrylate, the prepared binder is an emulsion-type binder. Specifically, a copolymer of at least one of alkyl (meth)acrylate and hydroxyalkyl (meth)acrylate, the comonomer (boric acid derivative) shown in Formula (1) and styrene, or a copolymer of at least one of alkyl (meth)acrylate and hydroxyalkyl (meth)acrylate, the comonomer (boric acid derivative) shown in Formula (1), styrene and the functional monomer are dispersed in a dispersion medium (such as water) to prepare the emulsion-type binder.

In an embodiment, when the matrix monomer is at least one of alkyl (meth)acrylate and hydroxyalkyl (meth)acrylate, the prepared binder is an emulsion-type binder. Specifically, a copolymer of at least one of alkyl (meth)acrylate and hydroxyalkyl (meth)acrylate and the comonomer (boric acid derivative) shown in Formula (1), or a copolymer of at least one of alkyl (meth)acrylate and hydroxyalkyl (meth)acrylate, the comonomer (boric acid derivative) shown in Formula (1) and the functional monomer are dispersed in a dispersion medium (such as water), to prepare the emulsion-type binder.

Wherein a particle size of the emulsion-type binder is 100-800 nm, in an implementation, 100-300 nm.

Wherein PDI of the emulsion-type binder is not more than 0.3, in an implementation, not more than 0.1.

Wherein a viscosity of the emulsion-type binder is 10-500 mPa·s, in an implementation, 50-250 mPa·s.

Wherein a solid content of the emulsion-type binder is 1-70 wt %, such as 5-65 wt %, 10-60 wt %, further such as 20-60 wt %, 30-60 wt %, in an implementation, 40-60 wt %.

The emulsion-type binder with the above selected parameters has good dispersion stability, stable bonding force, and is easy to disperse in use.

In an embodiment, when water is selected as the dispersion medium, it has the characteristics of no solvent release, meeting environmental requirements, non-combustion, low cost, safe in use and so on.

[Preparation Method of the Copolymer]

The present application further provides a method for preparing the copolymer, i.e., it is prepared by emulsion polymerization, and the method includes the following steps:
mixing the comonomer shown in Formula (1) with the matrix monomer and in an implementation, the functional monomer, introducing an inert gas and reacting to obtain the copolymer.

Wherein the comonomer shown in Formula (1), the matrix monomer and the functional monomer are defined as above.

In an embodiment, the inert gas is one of high-purity nitrogen and high-purity argon.

In an embodiment, a temperature of the reaction is 30-120° C., and time of the reaction is 5-24 h.

In an embodiment, an additive can be added in a reaction process according to difference of the matrix monomers and in an implementation, the functional monomers. Exemplarily, the additive includes at least one of an initiator, a cross-linking agent, an emulsifier and a buffer.

For example, the emulsifier is selected from one or more of anionic emulsifiers, cationic emulsifiers, amphoteric emulsifiers and nonionic emulsifiers. Exemplarily, the emulsifier is selected from one or more of SDS (sodium dodecyl sulfate), OP-10 (polyoxyethylene octylphenol ether-10), dodecyl trimethyl ammonium bromide, sodium dodecyl sulfonate, SDBS (sodium dodecylbenzene sulfonate), sodium dioctyl succinate sulfonate, p-nonylphenol poly(ethylene oxide) (n=4-40) ether, and poly(ethylene oxide) monolaurate.

For example, the initiator is selected from at least one of potassium persulfate, ammonium persulfate, 4,4′-azobis(4-cyanovaleric acid), 2,2′-azobis (2-methylpropion amidine) dihydrochloride, sodium persulfate, tetravalent cerium salt (e.g., ammonium cerium nitrate), potassium permanganate, sodium persulfate/sodium bisulfite, ferrous sulfate/hydrogen peroxide, ammonium persulfate/tetramethylethylenediamine, ammonium persulfate/sodium sulfite. Among them, sodium persulfate/sodium bisulfite, ferrous sulfate/hydrogen peroxide, ammonium persulfate/tetramethylethylenediamine, and ammonium persulfate/sodium sulfite respectively represent initiators used in combination, which can be added one after another when used.

For example, the buffer is selected from sodium bicarbonate or sodium phosphate dodecahydrate (Na₃PO₄·12H₂O).

For example, the cross-linking agent is selected from at least one of divinylbenzene, N,N-methylenebisacrylamide, ethylene glycol diacrylate, and ethylene glycol dimethyl acrylate.

[Preparation Method of the Binder]

The present application further provides a method for preparing the binder, including the following steps:

dispersing the copolymer in a dispersion medium (such as water) to prepare the binder, which is, in an implementation, an emulsion-type binder.

[Application of the Binder]

The present application further provides application of the above binder in a lithium-ion battery.

In an implementation, for the application in the positive and/or negative electrode of the lithium-ion battery, the binder is used as a binder for the negative electrode.

[Electrode Piece]

As described above, the present application provides an electrode piece, the electrode piece includes a current collector and an active material layer located on a surface of at least one side of the current collector, and the active material layer includes the above binder.

In an embodiment, the electrode piece is a positive electrode piece or a negative electrode piece.

In an embodiment, the current collector is a positive electrode current collector or a negative electrode current collector; wherein, the negative electrode current collector is selected from a single-sided glossy copper foil, a double-sided glossy copper foil or a porous copper foil; the positive electrode current collector is selected from a single-sided glossy copper foil, a double-sided glossy copper foil or a porous copper foil.

In an embodiment, a mass of the binder accounts for 0.5-5 wt % of a total mass of the active material layer, such as 0.8-2.5 wt %, and further such as 1.5-2.5 wt %.

In an embodiment, the active material layer further includes an active material and an additive.

In an embodiment, the active material is a positive electrode active material or a negative electrode active material, the negative electrode active material includes at least one of artificial graphite, natural graphite, mesophase carbon bead and lithium titanate, silicon oxide, nano-silicon powder, silicon monoxide, and silicon carbon; the positive electrode active material includes at least one of lithium iron phosphate, ternary positive electrode material and lithium cobaltate.

In an embodiment, the additive includes a conductive agent and/or a dispersant; in an implementation, the conductive agent is selected from at least one of graphite, carbon black, acetylene black, graphene, carbon nanotube; the dispersant is selected from sodium carboxymethyl cellulose or lithium carboxymethyl cellulose.

Wherein an amount of the conductive agent and/or dispersant in use is known in the field.

[Preparation Method of the Electrode Piece]

The present application further provides a method for preparing the above electrode piece, including the following steps:
coating a slurry including the above binder on a surface of at least one side of the current collector, to prepare the electrode piece.

In an embodiment, a method for preparing an negative electrode piece includes the following steps:
(1) mixing a negative active material, a conductive agent, a dispersant and the above binder evenly to obtain a negative electrode slurry;
(2) applying the negative electrode slurry to a surface of a current collector, and baking to obtain the negative electrode piece.

In an embodiment, the positive electrode piece is prepared by a method including the following steps:
(1) mixing a positive active material, a conductive agent and a positive electrode binder evenly to obtain a positive electrode slurry;
(2) applying the positive electrode slurry to a surface of a current collector, and baking to obtain the positive electrode piece.

Wherein the positive electrode binder can be at least one of the above binder, PVDF, polyacrylate and polyacrylic acid. In an implementation, the positive electrode binder is PVDF.

[Application of the Electrode Piece]

The present application further provides application of the above electrode piece in the lithium-ion battery.

[Lithium-Ion Battery]

As described above, the present application provides a lithium-ion battery, including the above binder and/or the above electrode piece.

In an embodiment, the lithium-ion battery includes a positive electrode piece, a negative electrode piece, a separator and an electrolyte.

In an embodiment, the lithium-ion battery is assembled from a positive electrode piece, a separator, a negative electrode piece and an electrolyte. For example, the positive electrode piece, negative electrode piece and separator are assembled into a battery cell through winding or stacking commonly used in the industry, and then encapsulated by an aluminum laminate film, and then sequentially subjected to baking, electrolyte injection, formation and secondary encapsulation, to obtain a lithium-ion battery.

The preparation method of the present application will be further explained in detail in combination with specific examples below. It should be understood that the following examples only exemplarily illustrate and explain the present application and should not be explained as a limitation on the scope of protection of the present application. All technologies realized based on the above contents of the present application are covered within the scope of protection of the present application.

The experimental methods used in the following examples are conventional methods unless otherwise specified, and the reagents, materials, etc. used in the following examples can be obtained from commercially available unless otherwise specified.

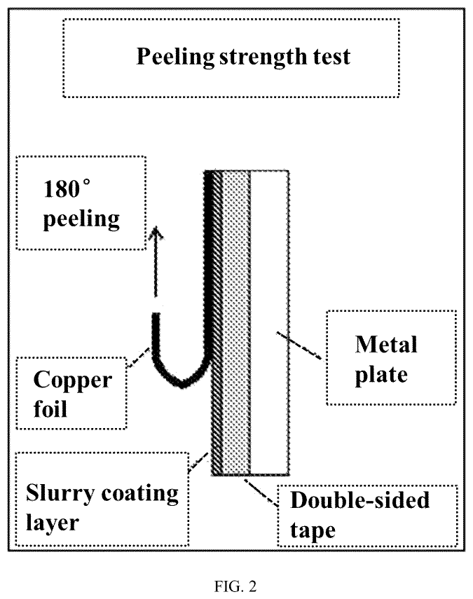

The peeling strength referred to in the following examples and comparative examples are measured by the following methods:
a negative electrode slurry is coated on a surface of a copper foil as current collector, dried and cold pressed into an electrode piece, and the prepared electrode piece is cut into test specimens with a size of 20×100 mm, as standbys; and one side of a double-sided tape is bonded to one side to be tested of an electrode piece specimen and compacted with a pressing roller to make it fully fit with the electrode piece; the other side of the double-sided tape on the specimen is adhered to a surface of a stainless steel, and one end of the specimen is bent reversely at a bending angle of 180°; using a high-speed rail tensile machine for testing, one end of the stainless steel is fixed to a lower fixture of the tension machine, the bent end of the specimen is fixed to an upper fixture of the tension machine, and an angle of the specimen is adjusted to ensure that the upper and lower ends are in a vertical position, and then the specimen is stretched at a speed of 50 mm/min until the negative electrode slurry is completely peeled off from the substrate, and the displacement and action force in the process are recorded, and a force at force balance is considered as the peeling strength of the electrode piece, and a schematic diagram of the device is as shown in FIG. 2.

The particle size and PDI data of emulsion particles in the following examples are measured by a laser particle size analyzer (Zatasizer Nano ZS90 from Malvern).

The viscosity referred to in the following examples and comparative examples is measured at room temperature (20-25° C.) using a digital-display rotary viscometer (Shanghai Sanono NDJ-5S).

The glass transition temperatures referred to in the following examples and comparative examples are measured by a differential scanning calorimeter (DSC), with model 910s (TA Instruments, USA).

### Example 1

30 parts (mass parts, same as below) of styrene, 70 parts of butadiene, 0.4 parts of acrylic acid, 0.1 parts of divinylbenzene, 2 parts of p-vinylphenylboric acid (shown in Formula (1-1)), 200 parts of water, 4.5 parts of sodium stearate and 0.5 parts of molecular weight regulator dodecyl mercaptan were added to a reactor in sequence, with nitrogen introduced for protection, stirred at 300 rpm and heated to 65° C. After continuously stirring for 20 minutes, 0.31 parts of potassium persulfate was added, kept at 60° C., condensed, and reacted for 7 h under stirring continuously at 300 rpm. After the reaction was ended, the pH value was adjusted with ammonia and the gel therein was filtered with 200 mesh gauze, to obtain an emulsion-type binder of a vinylphenyl boric acid modified styrene-butadiene rubber. The emulsion-type binder has a glass transition temperature of 16° C., an average particle size of 168 nm, PDI of 0.06, a viscosity of 10-50 mPa·s, a solid content of 40-42 wt %, and pH=6.5-7.5.

The positive active material lithium cobaltate, binder PVDF and conductive carbon black were dispersed in N-methylpyrrolidone, and stirred to obtain a uniformly dispersed positive electrode slurry, where the solid components include 96.8 wt % of lithium cobaltate, 1.3 wt % of PVDF and 2 wt % of conductive carbon black. The positive electrode slurry had a solid content of 67.5 wt %, and a viscosity of 21745 mPa·s. The positive electrode slurry was uniformly coated on both sides of an aluminum foil, dried at 100-130° C. for 4 h, and compacted by a roller press with a compaction density of 2.6-3.2 g/cm3 to obtain a positive electrode piece.

Graphite, the emulsion-type binder, dispersant CMC and conductive agent conductive carbon black are mixed and dispersed in deionized water to obtain a negative electrode slurry, in which the solid components include 95.5 wt % of graphite, 1.5 wt % of CMC, 1 wt % of conductive carbon black, 2 wt % of the above emulsion-type binder, and the negative electrode slurry had a solid content of 44-46 wt %, and a viscosity of 6561 mPa·s. The slurry was uniformly coated on both sides of a copper foil, dried at 70-100° C. for 5 h and compacted by a roller press with a compaction density of 1.4-1.7 g/cm³, to obtain a negative electrode piece.

The positive electrode piece, the negative electrode piece and a separator (PP/PE/PP composite film with thickness of 8 μm and porosity of 42%) were wound and encapsulated into a battery cell, and then subjected to electrolyte injection, formation, heat pressed, and secondary encapsulation to obtain a lithium-ion battery.

### Example 2

33 parts of styrene, 67 parts of butadiene, 0.15 parts of divinylbenzene, 3 parts of boric acid derivatives shown in Formula (1-3), 155 parts of water, 2 parts of acrylamide, 6 parts of sodium stearate and 0.6 parts of molecular weight regulator dodecyl mercaptan were added to a reactor in sequence, with nitrogen introduced for protection, stirred at 300 rpm, and heated to 60° C. After continuously stirring for 20 min, 0.3 parts of ammonium persulfate was added, kept at 65° C., condensed, and reacted for 6 h under stirring continuously at 300 rpm After the reaction was ended, pH was adjusted with ammonia and the gel therein was filtered with 200 mesh gauze, to obtain an emulsion-type binder of a carbon boric acid derivative modified styrene-butadiene rubber. The emulsion-type binder has a glass transition temperature of 20° C., an average particle size of 165 nm, PDI of 0.036, a viscosity of 15-50 mPa·s, a solid content of 39-41 wt % and pH of 7-8.

A process of preparing a lithium-ion battery is basically the same as that of Example 1, except that the binder used is the emulsion-type binder synthesized in the present example.

### Example 3

Octylphenol polyoxyethylene ether (OP-10) and sodium dodecyl sulfate (SDS) with a mass ratio of 1 to 1 as emulsifiers in total of 4 parts, 1 part of acrylamide, 33 parts of methyl methacrylate, 60 parts of butyl acrylate, 2 parts of hydroxyethyl acrylate, 3 parts of boric acid derivative shown in Formula (1-2), 0.15 parts of ethylene glycol diacrylate, 0.5 parts of ammonium persulfate, 0.5 parts of sodium bisulfate and 200 parts of water were added to a reactor to obtain a mixture. The emulsifiers (OP-10/SDS) and deionized water were added to the reactor by a semi-continuous method, stirred for 1 h, evenly mixed and emulsified, then heated to 40° C., with introduction of N2 (to exclude 02 in the system), added 1/10 parts of the mixed monomer (mixture of 33 parts of methyl methacrylate, 60 parts of butyl acrylate, 2 parts of hydroxyethyl acrylate, 3 parts of boric acid derivative shown in Formula (1-2), 0.15 parts of ethylene glycol diacrylate) and 1/3 parts of an initiator, and reacted at 45° C. for 1 h. Subsequently, the remaining mixed monomer and the initiator (controlling rate of dropwise addition) were added into the system simultaneously dropwise, and after the dropwise addition was completed, the reaction was continued for 5 h, and then the temperature was lowered to 25° C., the pH was adjusted to 7.0-8.0 with ammonia, to obtain a target, i.e., an emulsion-type binder of boric acid derivative modified acrylate. The emulsion-type binder has a glass transition temperature of 25° C., an average particle size of 185 nm, PDI of 0.03, a viscosity of 10-70 mPa·s, and a solid content of 36-39 wt %.

A process of preparing a lithium-ion battery is basically the same as that of Example 1, except that the emulsion-type binder used is the emulsion-type binder synthesized in the present Example.

### Example 4

0.05 parts of sodium dodecyl sulfate (SDS) as emulsifier, 0.05 parts, 40 parts of styrene, 60 parts of butyl acrylate, 1 parts of acrylamide, 0.1 parts of N,N-methylene bisacrylamide, 2 parts of boric acid derivative shown in Formula (1-4), and 200 parts of water were first added to a reactor, stirred, and heated, with introduction of N2 (to exclude 02 in the system); when the temperature was raised to 70° C., 0.35 parts of potassium persulfate was added and the reaction was continued for 8 h; the temperature was lowered to 40° C., pH was adjusted to 7.0-8.0 with sodium hydroxide, and then cooled, to obtain a target, i.e., an emulsion-type binder of boric acid derivative modified styrene-acrylate. The emulsion-type binder has a glass transition temperature of 10° C., an average particle size of 175 nm, PDI of 0.043, a viscosity of 10-60 mPa·s and a solid content of 38-41 wt %.

A process of preparing a lithium-ion battery is basically the same as that of Example 1, except that the binder used is the emulsion-type binder synthesized in the present Example.

### Comparative Example 1

Compared with Example 1, the difference is that no boric acid derivative monomer is added, and contents and preparation processes of other materials are consistent with those of Example 1.

### Comparative Example 2

Compared with Example 2, the difference is that no boric acid derivative monomer is added, and the contents and preparation processes of other materials are consistent with those of Example 2.

### Comparative Example 3

Compared with Example 3, the difference is that no boric acid derivative monomer is added, and the contents and preparation processes of other materials are consistent with those of Example 3.

### Comparative Example 4

Compared with Example 4, the difference is that no boric acid derivative monomer is added, and the contents and preparation processes of other materials are consistent with those of Example 4.

### Test Example 1

The performances of the batteries prepared by examples and comparative examples were tested, and the test items include low temperature performance (charging at 0° C., discharge at −20° C.), cycle retention rate and normal-temperature cycle expansion rate. The testing process is as follows:
(1) Low temperature performance: discharge at −20° C.: charge the battery at 0° C., then place the fully charged battery in a low temperature box at −20° C., discharge at 0.2 C, and then calculate the discharge capacity retention rate.
(2) Cycle retention rate: at room temperature 25° C., perform charge and discharge cycle at 1 C for 250 times, and then calculate the capacity retention rate after 250 cycles.
(3) Normal-temperature cycle expansion rate: at room temperature 25° C., perform charge and discharge cycle at 1 C for 250 times, and then calculate the percentage of the increased thickness to the original thickness of the battery after 250 times.

The electrical performance test results of the batteries of the above examples and comparative examples are shown in Table 1.

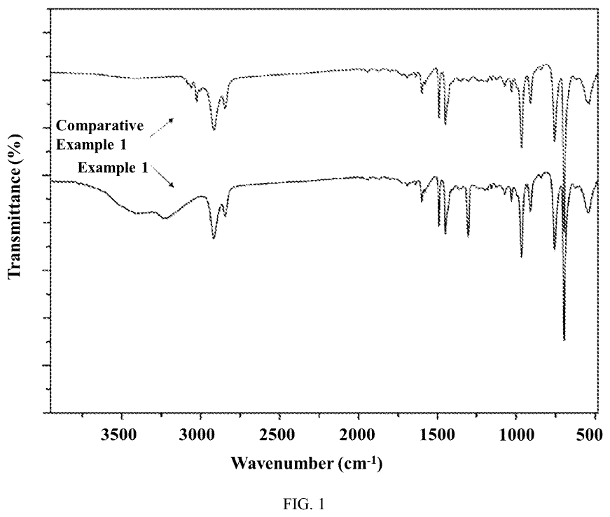

FIG. 1 is an infrared spectrum diagram of binders of Example 1 and Comparative Example 1. It can be seen from FIG. 1 that by introducing a boric acid derivative structure into Example 1, there are characteristic absorption peaks of the stretching vibrations of B—O and O—H at 1340 cm⁻¹ and 3200-3600 cm⁻¹ wavenumbers, while there are no obvious absorption peaks here in Comparative Example 1. Therefore it can be determined that the boric acid derivative monomer participated in copolymerization and was successfully introduced into the emulsion particles.

TABLE 1
Electrical performance test results of batteries of the examples and comparative examples

| | | Comparative | | Comparative | | Comparative | | Comparative |
|---|---|---|---|---|---|---|---|---|
| | Example 1 | Example 1 | Example 2 | Example 2 | Example 3 | Example 3 | Example 4 | Example 4 |
| Peeling strength (N/m) | 14.1 | 9.3 | 12.8 | 10.3 | 16.5 | 12.6 | 18.9 | 14.1 |
| Capacity retention rate | 82.1 | 71.8 | 84.7 | 73 | 83.6 | 75.6 | 85.7 | 80.2 |
| (%) after discharge at | | | | | | | | |
| 0.2 C and −20° C. | | | | | | | | |
| Cycle capacity retention | 93.5 | 87.2 | 91.4 | 83.8 | 92.2 | 87.9 | 94.6 | 88.4 |
| rate (%) after 250 T at | | | | | | | | |
| 1 C and room temperature | | | | | | | | |
| Cycle expansion rate (%) | 8 | 10.2 | 7.5 | 10.5 | 8.2 | 11.4 | 9.1 | 11.6 |
| after 250 T at 1 C and | | | | | | | | |
| room temperature | | | | | | | | |

It can be seen from Table 1 that the performances of the batteries with boric acid derivative modified binder all show advantages in peeling strength, discharge capacity retention rate at −20° C. and 0.2 C, capacity retention rate after 250 T charge-discharge cycle at 1 C and at room temperature and the expansion rate at room temperature, compared with the batteries without boric acid derivative modified binder.

The above explains the embodiments of the present application. However, the present application is not limited to the above embodiments. Any modifications, equivalent replacements and improvements made within the spirit and principle of the present application shall be included in the scope of protection of the present application.

What is claimed is:

1. A copolymer, wherein the copolymer is a copolymer of a matrix monomer and a comonomer shown in Formula (1): 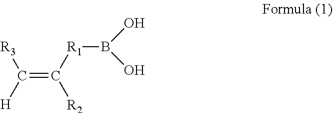
in Formula (1), R₁ is selected from —C₁₋₆alkylidene-, —C₆₋₁₂arylene- and —C(═O)—O—C₆₋₁₂arylene-; R₂ is selected from —H and —C₁₋₆alkyl; and R₃ is selected from —H and —C₁₋₆alkyl.

2. The copolymer according to claim 1, wherein the matrix monomer is selected from at least one of compounds shown in Formulas (2) and (3):
H₂C═CH—R₄ Formula (2)
H₂C═C(CH₃)—R₄ Formula (3)
in Formulas (2) and (3), R₄ is selected from —C(R₅)═C(R₅)₂, —C₆₋₁₂aryl and —C(═O)—O—R₆; wherein each R₅ is the same or different, and independently selected from —H and —C₁₋₆alkyl; and R₆ is selected from substituted or unsubstituted —C₁₋₆alkyl, with substitute group being selected from hydroxyl group.

3. The copolymer according to claim 1, wherein the comonomer shown in Formula (1) is selected from at least one of compounds shown in Formulas (1-1), (1-2), (1-3), (1-4) and (1-5):

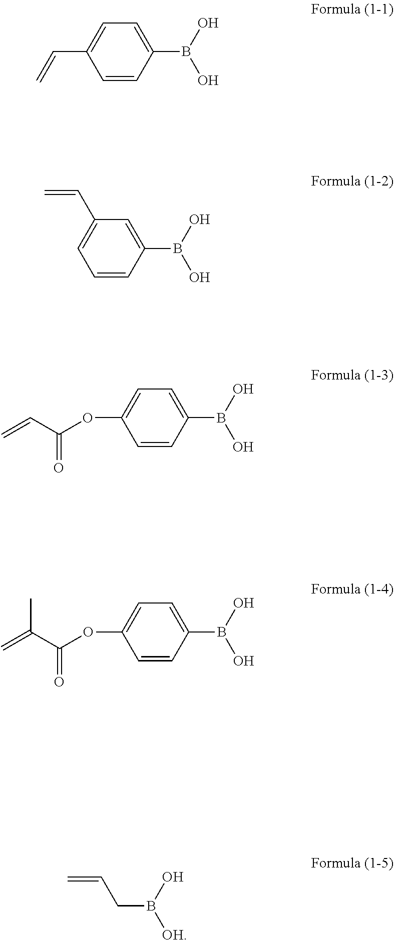

4. The copolymer according to claim 1, wherein the copolymer is a copolymer of the matrix monomer, the comonomer shown in Formula (1) and a functional monomer, the functional monomer is selected from at least one of acrylonitrile, (meth)acrylamide, (meth)acrylic acid, itaconic acid, 2-acrylamido-2-methylpropanesulfonic acid, allyl sulfonic acid, N-hydroxymethyl (meth)acrylamide, N,N-dimethyl acrylamide, sodium p-styrene sulfonate, sodium vinyl sulfonate, sodium allyl sulfonate, sodium 2-methylallyl sulfonate, sodium ethyl methacrylate sulfonate, hydroxyethyl (meth)acrylate, hydroxypropyl (meth)acrylate and dimethyl diallyl ammonium chloride; and/or
the matrix monomer is selected from butadiene and styrene; or, the matrix monomer is selected from at least one of alkyl (meth)acrylate and hydroxyalkyl (meth)acrylate; or, the matrix monomer is selected from styrene and at least one of the following compounds: alkyl (meth)acrylate and hydroxyalkyl (meth)acrylate.

5. The copolymer according to claim 4, wherein the comonomer shown in Formula (1) accounts for 0.1-10 wt % of a total mass of the copolymer, the matrix monomer accounts for 90-99.9 wt % of the total mass of the copolymer, and the functional monomer accounts for 0-10 wt % of the total mass of the copolymer.

6. The copolymer according to claim 1, wherein a glass transition temperature of the copolymer is −20° C. to 80° C.

7. A binder comprising the copolymer according to claim 1.

8. The binder according to claim 7, wherein the binder is an emulsion-type binder, a particle size of the emulsion-type binder is 100-800 nm; and/or a polydispersity index of the emulsion-type binder is not more than 0.3; and/or a viscosity of the emulsion-type binder is 10-500 mPa·s; and/or a solid content of the emulsion-type binder is 1-70 wt %.

9. A lithium-ion battery, comprising an electrode piece, wherein the electrode piece comprises a current collector and an active material layer located on a surface of at least one side of the current collector, and the active material layer comprises the binder according to claim 7.

10. The lithium-ion battery according to claim 9, wherein a mass of the binder accounts for 0.5-5 wt % of a total mass of the active material layer.
